(19) United States
(12) Patent Application Publication
(10) Pub. No.: US 2004/0268126 A1
(43) Pub. Date: Dec. 30, 2004

(54) Shared secret generation for symmetric key cryptography

(76) Inventors: Mithat C. Dogan, Sunnyvale, CA (US); Christopher Uhlik, Danville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/606,130

(22) Filed: Jun. 24, 2003

(51) Int. Cl. H04L 9/00

(52) U.S. Cl. 713/171; 380/277

(57) ABSTRACT

Each connection can have a different symmetric key derived from a previously exchanged master secret in a symmetric key cryptography scheme. In one embodiment, the invention includes establishing a master secret between the first communications device and a second communications device, perhaps during registration. Then a connection is opened between the first communications device and the second communications device. A connection secret is generated from the master secret, and using as a symmetric key during the life of the connection.

### BACKGROUND OF THE INVENTION

1. Field of the Invention

The present invention applies to the field of data encryption, and, in particular, to symmetric key cryptography.

2. Description of the Prior Art

In communications systems, data is encrypted to protect the privacy of the communication. There are several encryption methods, including public and symmetric key cryptography. Symmetric key cryptography relies on the originator and recipient of the communication sharing a secret that no one else knows. This shared secret is generally referred to as a symmetric key.

The symmetric key is used to initialize a cipher. A cipher is generally implemented as a finite state machine whose operation is random, but can be reproduced by knowing the initial state. Two categories of well-known ciphers are stream ciphers and block ciphers. Stream ciphers generally operate on a continuous stream of data, wherein block ciphers operate on data blocks, such as a block of 64 bits.

The symmetric key, i.e. shared secret, is generally exchanged before data communications commence. The same symmetric key is used until a new one is exchanged. Shared secret exchange requires overhead, and is computationally intensive. In a system where short connections are established periodically, such as a wireless radio data communications system, using a newly exchanged shared secret may be impractical. However, using the same symmetric key for multiple connections can erode the security provided by symmetric key cryptography.

### BRIEF SUMMARY OF THE INVENTION

Each connection can have a different symmetric key derived from a previously exchanged master secret in a symmetric key cryptography scheme. In one embodiment, the invention includes establishing a master secret between the first communications device and a second communications device, perhaps during registration. Then a connection is opened between the first communications device and the second communications device. A connection secret is generated from the master secret, and using as a symmetric key during the life of the connection.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a simplified block diagram of prior art symmetric key cryptography;

FIG. 2A is a simplified flow diagram of symmetric key generation according to one embodiment of the present invention;

FIG. 2B is a more detailed flow diagram of symmetric key generation according to one embodiment of the present t invention;

FIG. 3 is a simplified block diagram of implementing one embodiment of the present invention;

FIG. 4 is a simplified block diagram of a base station on which an embodiment of the invention can be implemented; and

FIG. 5 is a simplified block diagram of a user terminal on which an embodiment of the invention can be implemented.

### DETAILED DESCRIPTION OF THE INVENTION

In one embodiment, the present invention uses a master secret provided to the base station during registration to be used to produce a different stream secret to be used as a symmetric key for each steam. In one embodiment, the stream secret is a function of the master secret and the absolute frame number of the random access burst.

Symmetric Key Cryptography

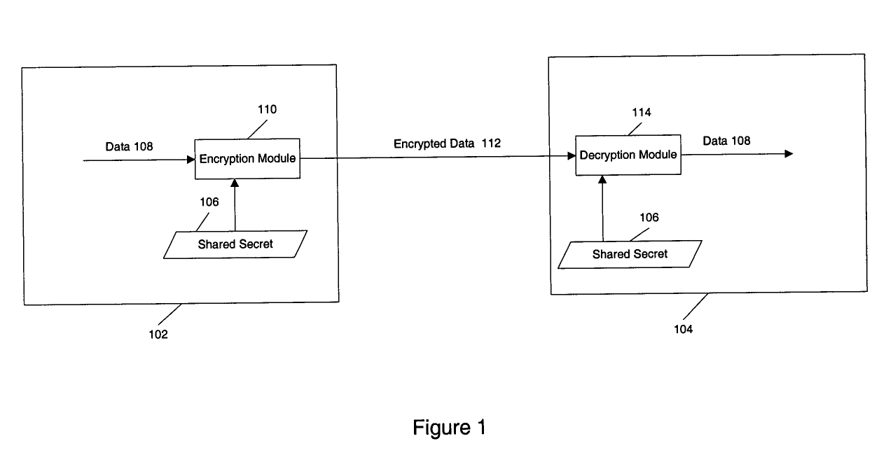

The conventional method of using symmetric key cryptography to encrypt data to be sent over a communications medium is now described with reference to FIG. 1. An originating communications device 102 wants to send data to a receiving communications device 104. Both communications devices have in their possession a shared secret 106. In one embodiment, the shared secret is initially exchanged using public key cryptography.

The data 108 that the originating device 102 is to transmit is first passed to an encryption module 110. The encryption module 110 uses symmetric key cryptography to encrypt the data 108 by using the shared secret as a symmetric key. That is, the symmetric key is used by the encryption module 110 to initialize a cipher that is used to encrypt the data 108.

The encrypted data 112 is then modulated and transmitted to the receiving device 104 over some communications medium, such as radio waves or a wireline connection. At the receiving device 104 the encrypted data is demodulated and passed to a decryption module 114. The decryption module 114 uses the same shared secret 106 to decrypt to the data 108 as the encryption module 110 used to encrypt the data 108. This is from where symmetric cryptography gets its name.

Connection-Specific Shared Secret

In one embodiment, the originating device is a user terminal of a radio communications system, such as a cellular data network, and the receiving device is a base station of this system, or vice versa. In such a system, a user terminal can establish a relationship with the base station that allows the user terminal access to the base station.

In one embodiment, this relationship is a registration, during which the user terminal is authenticated, various network and capability parameters are exchanged, and the user terminal is assigned a set of random access channels on which to request connections. In one embodiment, these connections are communications streams that are relatively quick circuit connections established on a traffic channel.

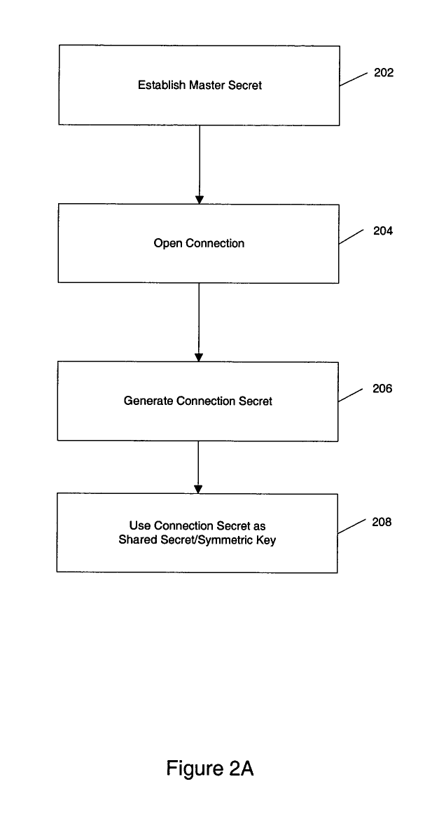

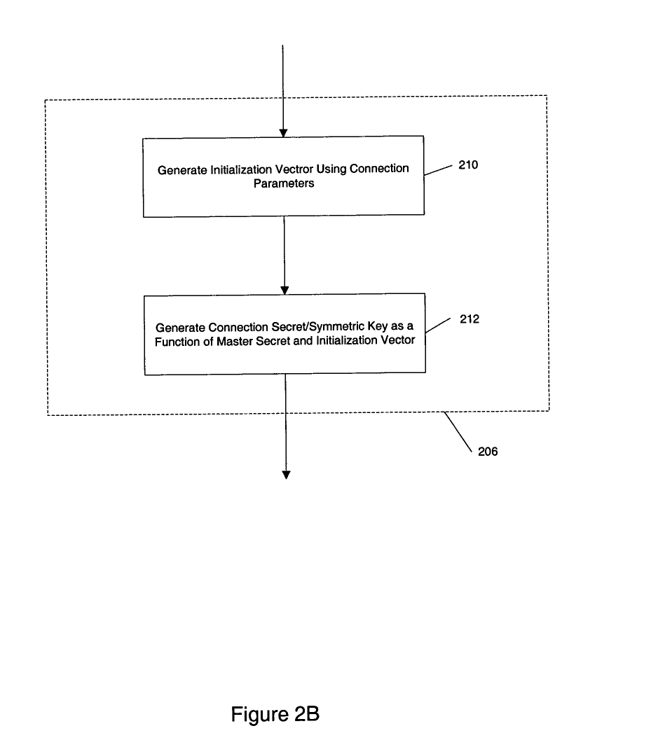

One embodiment of the invention is now described in this context with reference to FIG. 2A. FIG. 2A is a flowchart demonstrating the encryption procedure followed by a registered user terminal that sends data to a base station. First, the user terminal and the base station establish 202 a master secret in a fashion similar to exchanging a shared secret. In one embodiment, the master secret is larger than the symmetric key necessary for symmetric key cryptography. In one embodiment, the user terminal generates the master secret in a random fashion, and provides the master secret to the base station using public key cryptography. In one embodiment, the master secret is established during registration.

Next, the base station opens 204 a connection for a user terminal when the user terminal indicates it needs to send data. The opening of the connection can be accomplished by a random access burst from the user terminal requesting a traffic channel, and an access acknowledge burst from the base station granting the connection and assigning resources for the traffic channel. The resources can include a slot number of a TDMA frame and a frequency band of an FDMA scheme.

Next, the user terminal generates 206 a connection secret. The connection secret is generated from the master secret. Thus, only the base station and the user terminal can generate the connection secret. After the connection secret is generated it functions as the shared secret of a symmetric key cryptosystem. That is, for the duration of the connection, the user terminal and the base station use 208 the connection secret as the symmetric key.

There are various ways in which the connection secret can be generated from the master secret. However, it can be advantageous if the base station, i.e. receiving device, can also generate the connection secret from the master secret without further information from the originating device, in this case the user terminal.

One such embodiment is now described with reference to FIG. 2B. FIG. 2B shows block 206 from FIG. 2A. Thus, in such an embodiment, generating the connection secret first includes generating 210 an initialization vector. The initialization vector is a variable that is then used to generate 212 the connection secret. That is, the connection secret is a function of the master secret and the initialization vector.

As explained above, in this embodiment, the receiver device can generate the initialization vector independently of the originating device. Therefore, in this embodiment, the initialization vector cannot simply be a random number, since two separate devices cannot reproduce the same result independently. To address this concern, in one embodiment, the initialization vector includes a temporal parameter associated with the connection.

This parameter can be the time associated with the start of the connection, the time associated with some control message used to set up the connection, or some other time parameter. In one embodiment, this temporal parameter is the absolute frame number of the random access stream request burst sent by the user terminal—the burst used to request a connection from the base station. Since the absolute frame number never repeats during the life of the master secret, such a parameter does not result in two identical connection secrets.

In one embodiment, the initialization vector includes an air interface parameter. This parameter can be the slot number of a TDMA system in which the connection is established, the frequency band of an FDMA system in which the connection is established, the spreading code of a CDMA system for the connection, a combination of the above, or some other parameter related to the air interface on which the connection is established. In one embodiment, where numbers identifies channels, the channel ID can be included in the initialization vector. While it is possible that the same air-interface parameter is used more than once during the life of the master secret, forcing a different parameter, or including other non-duplicative parameters—such as absolute frame number—in the initialization vector can guarantee that two identical initialization vectors are not used during the life of one master secret.

One property of the parameters described above, which can be included in the initialization vector, is that both user terminal and base station—originating and receiving device—can independently generate the initialization vector. Since the initialization vector does not need to be transmitted, no additional key or vector exchange is necessary. Thus, after the master secret is exchanged, no additional overhead is necessary to generate connection secrets outside of performing the connection secret generating function with the master secret and the initialization vector. By having such an implicit initialization vector, overhead is reduced and security is increased because attackers cannot intercept the initialization vector that is not transmitted.

There are various functions that can be used to generate a connection secret from a master secret and an initialization vector. For example, the function can interleave the master secret bits and the initialization vector bits, and concatenate the result to produce the connection secret. In another embodiment, instead of concatenating the result of the interleaving, the function can produce a constant bit number hash of the result to produce the connection secret. Such a hash function can be a cryptographically secure hash such as the MD5, the SHA-1 or some other known hash function. There are numerous other functions of the master secret and initialization vector that can be used.

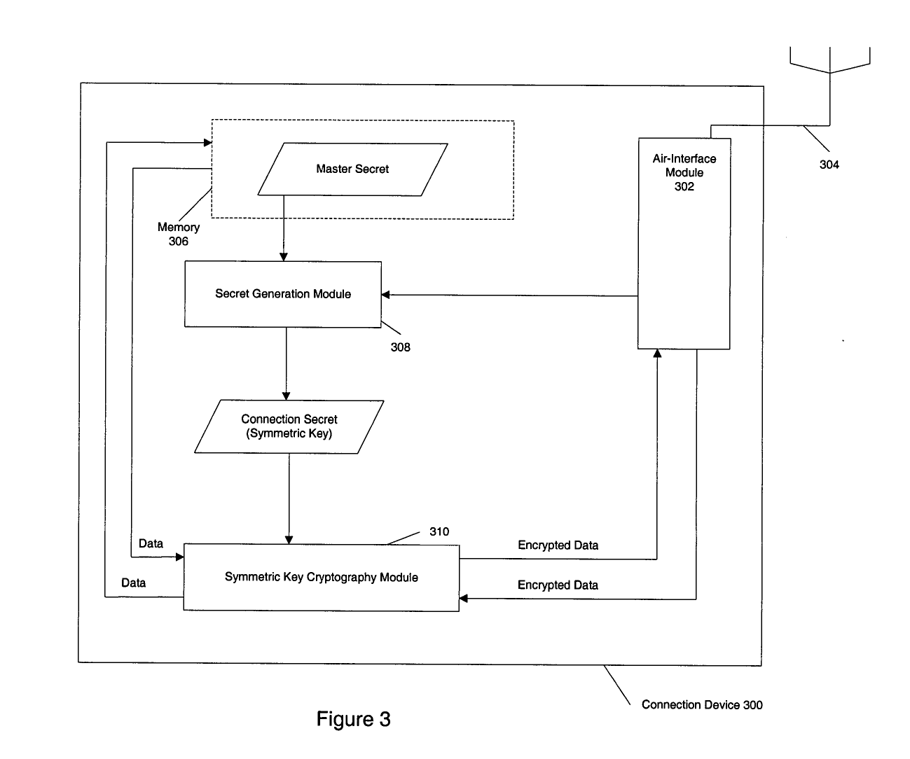

One embodiment of a modular communications device that implements an embodiment of the present invention is now described with reference to FIG. 3. Communications device 300 has an air-interface module 302 to communicate with other devices using an antenna 304. The air-interface module handles the radio communications functionalities, such as connection setup and termination.

The communications device 300 further has a memory 306. The master secret—which was either generated or received from the air interface module 302—is stored in the memory 306. A secret generation module 308 produces a connection secret from the master secret stored in memory 306 and from temporal and air-interface parameters associated with the connection gathered from the air-interface module 302.

A cryptography module 310 uses the connection secret as a symmetric key for each connection. During the connection, the cryptography module 310 decrypts encrypted data from the air-interface module 302 with a cipher initialized with the connection secret generated by the secret generation module 308. Conversely, the cryptography module 310 encrypts data from a data source—such as the memory 306—with a cipher initialized with the connection secret generated by secret generation module 308. The data thus encrypted is then sent to the air-interface module 302 for transmission over the connection.

Base Station Structure

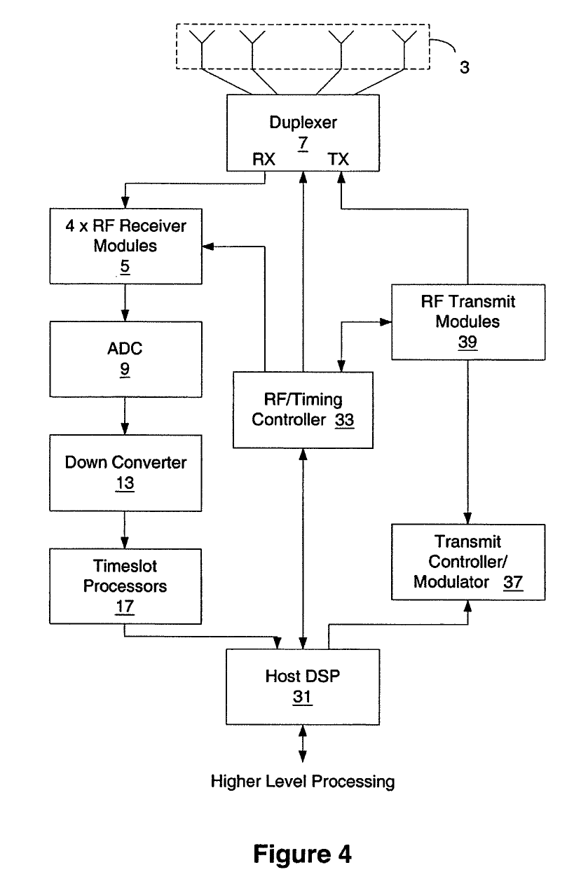

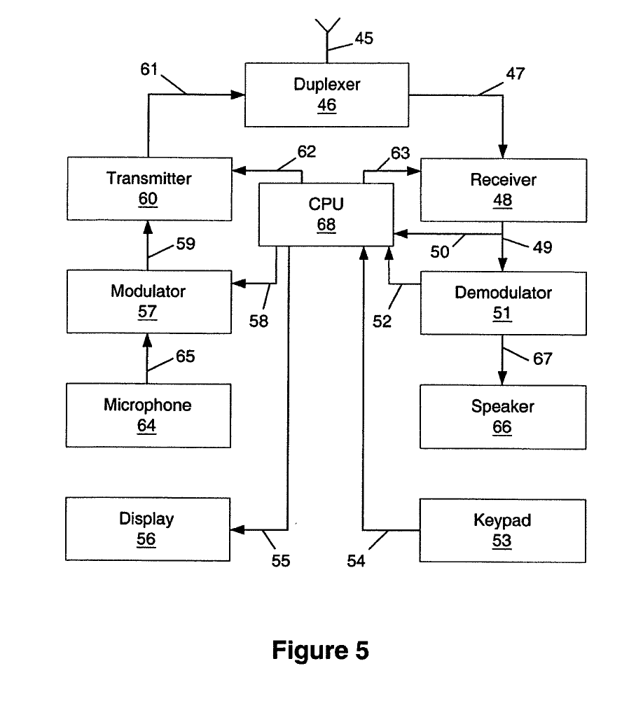

The encryption module 200 and encryption/decryption method described with reference to FIGS. 2 and 3A-3B can be used for data encryption in any communications system. In one embodiment, they can be used in a wireless radio communications system. A base station and a user terminal of such a radio communications network is now described. FIG. 4 shows an example of a base station of a wireless communications system or network suitable for implementing the present invention. The system or network includes a number of subscriber stations, also referred to as remote terminals or user terminals, such as that shown in FIG. 5. The base station may be connected to a wide area network (WAN) through its host DSP 31 for providing any required data services and connections external to the immediate wireless system. To support spatial diversity, a plurality of antennas 3 is used, for example four antennas, although other numbers of antennas may be selected.

A set of spatial multiplexing weights for each subscriber station are applied to the respective modulated signals to produce spatially multiplexed signals to be transmitted by the bank of four antennas. The host DSP 31 produces and maintains spatial signatures for each subscriber station for each conventional channel and calculates spatial multiplexing and demultiplexing weights using received signal measurements. In this manner, the signals from the current active subscriber stations, some of which may be active on the same conventional channel, are separated and interference and noise suppressed. When communicating from the base station to the subscriber stations, an optimized multi-lobe antenna radiation pattern tailored to the current active subscriber station connections and interference situation is created. Suitable smart antenna technologies for achieving such a spatially directed beam are described, for example, in U.S. Pat No. 5,828,658, issued Oct. 27, 1998 to Ottersten et al. and U.S. Pat No. 5,642,353, issued Jun. 24, 1997 to Roy, III et al. The channels used may be partitioned in any manner. In one embodiment the channels used may be partitioned as defined in the GSM (Global System for Mobile Communications) air interface, or any other time division air interface protocol, such as Digital Cellular, PCS (Personal Communication System), PHS (Personal Handyphone System) or WLL (Wireless Local Loop). Alternatively, continuous analog or CDMA channels can be used.

The outputs of the antennas are connected to a duplexer switch 7, which in a TDD embodiment, may be a time switch. Two possible implementations of the duplexer switch are as a frequency duplexer in a frequency division duplex (FDD) system, and as a time switch in a time division duplex (TDD) system. When receiving, the antenna outputs are connected via the duplexer switch to a receiver 5, and are converted down in analog by RF receiver (“RX”) modules 5 from the carrier frequency to an FM intermediate frequency (“IF”). This signal then is digitized (sampled) by analog to digital converters (“ADCs”) 9. Final down-converting to baseband is carried out digitally. Digital filters can be used to implement the down-converting and the digital filtering, the latter using finite impulse response (FIR) filtering techniques. This is shown as block 13. The invention can be adapted to suit a wide variety of RF and IF carrier frequencies and bands.

There are, in the present example, eight down-converted outputs from each antenna's digital filter 13, one per receive timeslot. The particular number of timeslots can be varied to suit network needs. While GSM uses eight uplink and eight downlink timeslots for each TDMA frame, desirable results can also be achieved with any number of TDMA timeslots for the uplink and downlink in each frame. For each of the eight receive timeslots, the four down-converted outputs from the four antennas are fed to a digital signal processor (DSP) 17 (hereinafter “timeslot processor”) for further processing, including calibration, according to one aspect of this invention. Eight Motorola DSP56300 Family DSPs can be used as timeslot processors, one per receive timeslot. The timeslot processors 17 monitor the received signal power and estimate the frequency offset and time alignment. They also determine smart antenna weights for each antenna element. These are used in the SDMA scheme to determine a signal from a particular remote user and to demodulate the determined signal.

The output of the timeslot processors 17 is demodulated burst data for each of the eight receive timeslots. This data is sent to the host DSP processor 31 whose main function is to control all elements of the system and interface with the higher level processing, which is the processing which deals with what signals are required for communications in all the different control and service communication channels defined in the system's communication protocol. The host DSP 31 can be a Motorola DSP56300 Family DSP. In addition, timeslot processors send the determined receive weights for each user terminal to the host DSP 31. The host DSP 31 maintains state and timing information, receives uplink burst data from the timeslot processors 17, and programs the timeslot processors 17. In addition it decrypts, descrambles, checks error correcting code, and deconstructs bursts of the uplink signals, then formats the uplink signals to be sent for higher level processing in other parts of the base station. Furthermore DSP 31 may include a memory element to store data, instructions, or hopping functions or sequences. Alternatively, the base station may have a separate memory element or have access to an auxiliary memory element. With respect to the other parts of the base station it formats service data and traffic data for further higher processing in the base station, receives downlink messages and traffic data from the other parts of the base station, processes the downlink bursts and formats and sends the downlink bursts to a transmit controller/modulator, shown as 37. The host DSP also manages programming of other components of the base station including the transmit controller/modulator 37 and the RF timing controller shown as 33.

The RF timing controller 33 interfaces with the RF system, shown as block 45 and also produces a number of timing signals that are used by both the RF system and the modem. The RF controller 33 reads and transmits power monitoring and control values, controls the duplexer 7 and receives timing parameters and other settings for each burst from the host DSP 31.

The transmit controller/modulator 37, receives transmit data from the host DSP 31. The transmit controller uses this data to produce analog IF outputs which are sent to the RF transmitter (TX) modules 35. Specifically, the received data bits are converted into a complex modulated signal, up-converted to an IF frequency, sampled, multiplied by transmit weights obtained from host DSP 31, and converted via digital to analog converters (“DACs”) which are part of transmit controller/modulator 37 to analog transmit waveforms. The analog waveforms are sent to the transmit modules 35. The transmit modules 35 up-convert the signals to the transmission frequency and amplify the signals. The amplified transmission signal outputs are sent to antennas 3 via the duplexer/time switch 7.

User Terminal Structure

FIG. 5 depicts an example component arrangement in a remote terminal that provides data or voice communication. The remote terminal's antenna 45 is connected to a duplexer 46 to permit the antenna 45 to be used for both transmission and reception. The antenna can be omni-directional or directional. For optimal performance, the antenna can be made up of multiple elements and employ spatial processing as discussed above for the base station. In an alternate embodiment, separate receive and transmit antennas are used eliminating the need for the duplexer 46. In another alternate embodiment, where time division duplexing is used, a transmit/receive (TR) switch can be used instead of a duplexer as is well known in the art. The duplexer output 47 serves as input to a receiver 48. The receiver 48 produces a down-converted signal 49, which is the input to a demodulator 51. A demodulated received sound or voice signal 67 is input to a speaker 66.

The remote terminal has a corresponding transmit chain in which data or voice to be transmitted is modulated in a modulator 57. The modulated signal to be transmitted 59, output by the modulator 57, is up-converted and amplified by a transmitter 60, producing a transmitter output signal 61. The transmitter output 61 is then input to the duplexer 46 for transmission by the antenna 45.

The demodulated received data 52 is supplied to a remote terminal central processing unit 68 (CPU) as is received data before demodulation 50. The remote terminal CPU 68 can be implemented with a standard DSP (digital signal processor) device such as a Motorola series 56300 Family DSP. This DSP can also perform the functions of the demodulator 51 and the modulator 57. The remote terminal CPU 68 controls the receiver through line 63, the transmitter through line 62, the demodulator through line 52 and the modulator through line 58. It also communicates with a keyboard 53 through line 54 and a display 56 through line 55. A microphone 64 and speaker 66 are connected through the modulator 57 and the demodulator 51 through lines 65 and 66, respectively for a voice communications remote terminal. In another embodiment, the microphone and speaker are also in direct communication with the CPU to provide voice or data communications. Furthermore remote terminal CPU 68 may also include a memory element to store data, instructions, and hopping functions or sequences. Alternatively, the remote terminal may have a separate memory element or have access to an auxiliary memory element.

In one embodiment, the speaker 66, and the microphone 64 are replaced or augmented by digital interfaces well-known in the art that allow data to be transmitted to and from an external data processing device (for example, a computer). In one embodiment, the remote terminal's CPU is coupled to a standard digital interface such as a PCMCIA interface to an external computer and the display, keyboard, microphone and speaker are a part of the external computer. The remote terminal's CPU 68 communicates with these components through the digital interface and the external computer's controller. For data only communications, the microphone and speaker can be deleted. For voice only communications, the keyboard and display can be deleted.

General Matters

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, such as those shown in FIGS. 3 and 4, or may be embodied in machine-executable instructions, which may be used to cause a general-purpose or special-purpose processor or logic circuits programmed with the instructions to perform the steps. Alternatively, the steps may be performed by a combination of hardware and software. The steps have been described as being performed by either the base station or the user terminal. However, many of the steps described as being performed by the base station may be performed by the user terminal and vice versa. Furthermore, the invention is equally applicable to systems in which terminals communicate with each other without either one being designated as a base station, a user terminal, a remote terminal or a subscriber station. Thus, the present invention is equally applicable and useful in a peer-to-peer wireless network of communications devices using spatial processing. These devices may be cellular phones, PDA's, laptop computers, or any other wireless devices. Generally, since both the base stations and the terminals use radio waves, these communications devices of wireless communications networks may be generally referred to as radios.

In portions of the description above, only the base station is described as performing spatial processing using an antenna array. However, the user terminals can also contain antenna arrays, and can also perform spatial processing both on receiving and transmitting (uplink and downlink) within the scope of the present invention.

Embodiments of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and calculations are described in their most basic form, but steps can be added to or deleted from any of the methods and information can be added or subtracted from any of the described message signals without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

What is claimed is:

1. A method comprising:
establishing a master secret between a first communications device and a second communications device;
opening a connection between the first communications device and the second communications device;
generating a connection secret from the master secret; and
using the connection secret for symmetric key cryptography during the connection.

2. The method of claim 1, wherein using the connection secret for symmetric key cryptography comprises:
initializing a cipher using the connection secret; and
sending one or more bursts over the connection, the one or more bursts carrying data encrypted using the initialized cipher.

3. The method of claim 1, wherein using the connection secret for symmetric key cryptography comprises:
initializing a cipher using the connection secret;
receiving one or more bursts over the connection, the one or more bursts carrying data encrypted using the initialized cipher; and
decrypting the data using the initialized cipher.

4. The method of claim 1, wherein generating the connection secret comprises generating an initialization vector and determining the connection secret using the master secret and the initialization vector.

5. The method of claim 4, wherein the initialization vector comprises a temporal parameter.

6. The method of claim 5, wherein the temporal parameter comprises an absolute frame number related to the opening of the connection.

7. The method of claim 4, wherein the initialization vector comprises one or more air interface parameters.

8. The method of claim 7, wherein the air interface parameters comprise a slot number and a frequency band identifier of a channel allocated to the connection.

9. The method of claim 4, wherein the first communications device does not sent the initialization vector to the second communications device.

10. The method of claim 1, further comprising:
opening a second connection between the first communications device and the second communications device;
generating a second connection secret from the master secret; and
using the second connection secret for symmetric key cryptography during the second connection.

11. The method of claim 1, wherein the connection comprises a communications stream.

12. The method of claim 2, wherein the cipher comprises a stream cipher.

13. The method of claim 12, wherein the stream cipher comprises an RC4 cipher.

14. A communications device comprising:
a memory to store a master secret being known only by the communications device and a second communications device;
a secret generation module coupled to the memory to generate a connection secret from the master secret in response to the communications device opening a connection with the second communications device; and
an symmetric key cryptography module to use the connection secret during the connection for symmetric key cryptography.

15. The communications device of claim 14, wherein the symmetric key cryptography module uses the connection secret as a symmetric key when encrypting data.

16. The communications device of claim 15, wherein the symmetric key cryptography module initializes a cipher with the connection secret.

17. The communications device of claim 15, further comprising a transmitter to send one or more bursts over the connection, the one or more bursts carrying data encrypted using the initialized cipher.

18. The communications device of claim 14, wherein the symmetric key cryptography module uses the connection secret as a symmetric key when decrypting encrypted data.

19. The communications device of claim 18, wherein the symmetric key cryptography module initializes a cipher with the connection secret.

20. The communications device of claim 15, further comprising a receiver to receive one or more bursts over the connection, the one or more bursts carrying the encrypted data.

21. The communications device of claim 14, further comprising an air-interface device coupled to the secret generation module to establish and maintain the connection.

22. The communications device of claim 21, wherein the secret generation module generates the connection secret using a temporal parameter related to the connection.

23. The communications device of claim 22, wherein the temporal parameter comprises an absolute frame number related to the opening of the connection by the air-interface module.

24. The communications device of claim 21, wherein the secret generation module generates the connection secret using one or more air interface parameter related to the connection.

25. The communications device of claim 24, wherein the one or more air interface parameters comprise a slot number and a frequency band identifier of a channel allocated to the connection from the air-interface module.

26. A machine-readable medium storing data representing instructions that, when executed by a processor of a first communications device, cause the processor to perform operations comprising:
establishing a master secret between the first communications device and a second communications device;
opening a connection between the first communications device and the second communications device;
generating a connection secret from the master secret; and
using the connection secret for symmetric key cryptography during the connection.

27. The machine-readable medium of claim 26, wherein using the connection secret for symmetric key cryptography comprises:
initializing a cipher using the connection secret; and
sending one or more bursts over the connection, the one or more bursts carrying data encrypted using the initialized cipher.

28. The machine-readable medium of claim 26, wherein using the connection secret for symmetric key cryptography comprises:
initializing a cipher using the connection secret;
receiving one or more bursts over the connection, the one or more bursts carrying data encrypted using the initialized cipher; and
decrypting the data using the initialized cipher.

29. The machine-readable medium of claim 26, wherein generating the connection secret comprises generating an initialization vector and determining the connection secret using the master secret and the initialization vector.

30. The machine-readable medium of claim 29, wherein the initialization vector comprises a temporal parameter.

31. The machine-readable medium of claim 30, wherein the temporal parameter comprises an absolute frame number related to the opening of the connection.

32. The machine-readable medium of claim 29, wherein the initialization vector comprises one or more air interface parameters.

33. The machine-readable medium of claim 32, wherein the air interface parameters comprise a slot number and a frequency band identifier of a channel allocated to the connection.

34. The machine-readable medium of claim 29, wherein the first communications device does not sent the initialization vector to the second communications device.

35. The machine-readable medium of claim 26, wherein the instructions further cause the processor to perform operations comprising:
opening a second connection between the first communications device and the second communications device;
generating a second connection secret from the master secret; and
using the second connection secret for symmetric key cryptography during the second connection.

36. The machine-readable medium of claim 26, wherein the connection comprises a communications stream.

37. The machine-readable medium of claim 2, wherein the cipher comprises a stream cipher.
